(19) United States
(12) Patent Application Publication
(10) Pub. No.: US 2026/0066752 A1
(43) Pub. Date: Mar. 5, 2026

(54) ALIGNING APPARATUS FOR HAIRPIN TYPE STATOR COIL

(71) Applicants: HYUNDAI MOTOR COMPANY, Seoul (KR); Kia Corporation, Seoul (KR)

(72) Inventors: Yeongsu YU, Hwaseong-si (KR); Heedong SON, Hwaseong-si (KR); Jeong Hyeon KIM, Hwaseong-si (KR); Jae Ho HWANG, Hwaseong-si (KR); Jiwon YU, Hwaseong-si (KR); Heewoong KIM, Hwaseong-si (KR); Namhyun KIM, Hwaseong-si (KR); Hee Chang CHOI, Hwaseong-si (KR); Sunghyun JU, Hwaseong-si (KR); Sungdae HYUN, Hwaseong-si (KR); Gwangwon SUNG, Hwaseong-si (KR)

(21) Appl. No.: 19/312,852

(22) Filed: Aug. 28, 2025

(30) Foreign Application Priority Data
Sep. 3, 2024 (KR) 10-2024-0119052

(51) Int. Cl. H02K 15/0643; B25J 11/00; B25J 13/08; B25J 15/00; H02K 15/026

(52) U.S. Cl. CPC H02K 15/0643; B25J 11/005; B25J 13/086; B25J 15/0033; H02K 15/026; H02K 2215/00

(57) ABSTRACT

An aligning apparatus for a hairpin type stator coil includes a frame, at least one storage including storage guides, which are arranged in a storage stacking portion installed in the frame and are inclined downward, and on which I-shaped stator coils are loaded, at least one cartridge including cartridge guides arranged in a downward direction and loading the I-shaped stator coils which are taken out from the at least one storage, and the at least one cartridge arranged in front of at least one storage to extract the I-shaped stator coils, and a robot gripper configured to move along a predetermined path by a handling robot to grip and un-grip the I-shaped stator coils, which are output one by one from the at least one cartridge, and insert the I-shaped stator coils into a predetermined position in the alignment jig.

### CROSS-REFERENCE TO RELATED APPLICATION

This application claims priority to and the benefit of Korean Patent Application No. 10-2024-0119052, filed in the Korean Intellectual Property Office, on Sep. 3, 2024, the entire contents of which are incorporated herein by reference.

### TECHNICAL FIELD

The present disclosure relates to a manufacturing system for a hairpin winding type stator, and more particularly, the present disclosure relates an aligning apparatus for a hairpin type stator coil inserted into a stator core.

### BACKGROUND

Hybrid vehicles or electric vehicles, which are called environment-friendly vehicles, may apply technology that generates driving torque by a drive motor. As part of efforts to reduce the weight and volume of vehicles and components, automakers and environment-friendly parts manufacturers are developing drive motors with stators wound with hairpin-type stator coils.

In some cases, the hairpin winding type stators may be manufactured through a process of winding hairpin type stator coils onto a stator core, and a process of welding the stator coils wound onto the stator core.

The winding process of hairpin type stator coils may apply a method of gripping each stator coil and inserting it into a separate alignment jig, and then inserting the stator coils aligned in the alignment jig into the slots of the stator core.

In some cases, the process of aligning stator coils on an alignment jig uses a method of gripping each U-shaped stator coil by a multi-axis robot and inserting them into the alignment jig, and then manually inserting I-shaped stator coils into the alignment jig.

In some cases, these processes may involve additional equipment due to manual labor. Additional devices include, for example, a Fool Proof device for verifying the alignment of the I-type stator coils, and a logistics device for discharging and re-introducing the alignment jig when the I-type stator coils are misaligned.

### SUMMARY

The present disclosure attempts to provide an aligning apparatus for a hairpin type stator coil, which can automatically align I-type stator coils on an alignment jig in which U-type stator coils are aligned.

An aligning apparatus for a hairpin type stator coil, which automatically aligns I-shaped stator coils to an alignment jig in which U-shaped stator coils are aligned, the aligning apparatus can include a frame, at least one storage including storage guides, which are arranged in a storage stacking portion installed in the frame and are inclined downward from the rear to the front, and on which the I-shaped stator coils are loaded, at least one cartridge including cartridge guides arranged in a downward direction from the rear to the front and loading the I-shaped stator coils which are taken out from the at least one storage, and the at least one cartridge arranged in front of at least one storage to extract the I-shaped stator coils one by one, and a robot gripper capable of moving along a predetermined path by a handling robot to grip and un-grip the I-shaped stator coils, which are taken out one by one from at least one cartridge, and insert the I-shaped stator coils into a predetermined position in the alignment jig.

The storage stacking portion can include a stack base fixed to the frame, and a storage docking cylinder installed on the stack base and connected to at least one storage.

The at least one storage can include a storage base which is connected to the storage docking cylinder and is movable in the forward and backward direction to the stack base, a storage body which is fixed to the storage base and on which the storage guides are mounted, a storage door installed at the front of the storage body to support the I-shaped stator coils loaded on the storage guides, and a storage door driver installed on the stack base to open and close the storage door.

The storage door can include a door plate which is mounted so as to be movable in the left-right direction on a door mount block fixed to the storage base, and an upper storage stopper, a medium storage stopper, and a lower storage stopper mounted along the vertical direction on the door plate.

The storage door driver can include a door operating bracket mounted movably in the left-right direction on the stack base in order to move the door plate in the left-right direction, and a storage door operating cylinder which is installed on the stack base and connected to the door operating bracket.

The at least one cartridge can include a cartridge body installed on the frame, and equipped with the cartridge guides connectable with the storage guides, a main stopper installed at the front portion of the cartridge body to support the I-shaped stator coils loaded on the cartridge guides, an upper stopper block assembly and a lower stopper block assembly mounted so as to be movable in the left-right direction at the front portion of the cartridge body, a sub-stopper driving cylinder which is installed in the cartridge body and connected to the upper stopper block assembly and the lower stopper block assembly through a stopper driving block which can move forward and backward along the front-rear direction, a coil clamper mounted on the upper stopper block assembly to clamp the I-shaped stator coils positioned behind the frontmost I-shaped stator coil among the I-shaped stator coils loaded on the cartridge guides, and a sub-stopper mounted on the upper stopper block assembly and the lower stopper block assembly to support and extract the frontmost I-shaped stator coil.

The main stopper can include a head stopper connected to an upper main driving cylinder installed in the cartridge body to support the head part of the I-shaped stator coils loaded on the cartridge guides, and a leg stopper connected to a lower main driving cylinder installed in the cartridge body to support the leg parts of the I-shaped stator coils loaded on the cartridge guides.

An upper cam protrusion can be formed on the upper side of the stopper driving block, and a lower cam protrusion can be formed on the lower side of the stopper driving block.

An upper cam follower portion connected with the upper cam protrusion portion can be formed diagonally along the front-rear direction of the upper stopper block assembly.

A lower cam follower can be formed diagonally along the front-rear direction of the lower stopper block assembly and is connected to the lower cam protrusion.

The sub-stopper module can include at least one upper cartridge stopper mounted on the upper stopper block assembly to support the head part of the I-shaped stator coil of the frontmost, and at least one lower cartridge stopper mounted on the lower stopper block assembly to support the leg part of the frontmost I-shaped stator coil.

The robot gripper can include a mounting bracket fixed to the handling robot, a moving block provided to enable forward and backward movement by the operation of a gripper sub-driving cylinder installed on the mounting bracket, a pair of gripper bodies which are provided so as to be able to move in a direction toward or away from each other by the operation of a gripper main driving cylinder installed in the moving block, and a pair of coil guide pins mounted on the moving block.

The robot gripper can include a sensor dog block mounted in a vertical direction movably on a fixing bracket fixed to the mounting bracket, and a proximity sensor installed in the fixing bracket on the upper side corresponding to the sensor dog block.

Each of the gripper body can include a gripping groove formed such that the leg part of the I-shaped stator coil is fitted along the vertical direction, and at least one gradient protrusion and at least one gradient groove portion connected to the gripping groove and formed so as to be able to overlap each other.

The alignment jig can include a rotation shaft that is docked and connected to a jig docking part installed on the frame and rotatably mounted on the jig base, at least one fixing ring connected to the rotation shaft, a plurality of jig pins radially arranged in at least one fixing ring, and at least one jig spring radially arranged within a predetermined exterior circumference section of the at least one fixing ring.

The alignment jig can further include a support ring fixed to the jig base with at least one fixing ring placed inside, and a plurality of coil pocket units radially movably mounted on the support ring to guide the leg part of the I-shaped stator coil to be inserted into predetermined positions of the jig pins by the robot gripper.

Each of the coil pocket unit can include a pocket block radially movably connected to the support ring and connected to the support ring via at least one guide rod, and at least one guide block connected to the pocket block and to which a pocket guide hole is formed along the vertical direction.

The aligning apparatus for a hairpin type stator coil can further include a pocket moving unit installed on a base part connected to the jig docking part to move the coil pocket units outside the radius of the support ring.

The pocket moving unit can include a fixing plate that is configured to move in the left-right direction and vertical direction by the operation of a first operation cylinder and a t second operation cylinder installed on the base part, and a plurality of cam blocks mounted on the fixing plate at positions corresponding to the pocket block and in cam contact with a cam roller rotatably mounted on the pocket block.

The aligning apparatus for a hairpin type stator coil can further include a coil extension part installed on the frame at a position corresponding to the alignment jig so as to pull the U-shaped stator coils aligned on the alignment jig.

The aligning apparatus for a hairpin type stator coil can further include a jig supporter installed on the frame to support the alignment jig that moves by the coil extension part.

The aligning apparatus for a hairpin type stator coil can further include a coil detector installed in the frame to detect the I-shaped stator coils inserted into the alignment jig.

The coil extension part can include a pull block configured to move along the front-rear direction and in the vertical direction by the operation of a third operation cylinder and a fourth operation cylinder installed in the frame.

The jig supporter can include a jig support block configured to move in the front-rear direction by the operation of a fifth operation cylinder installed on the frame.

The coil detector can include a sensor block configured to move in the front-rear direction and left-right direction by the operation of a sixth operation cylinder and a seventh cylinder installed in the frame, and a pair of head detecting sensors mounted along the vertical direction on the sensor block.

According to the aligning apparatus for the hairpin type stator coil, process automation can be implemented, so labor costs can be reduced and cycle time can be shortened.

In addition, according to the aligning apparatus for the hairpin type stator coil, the position dispersion of the I-type stator coils is absorbed, and the I-type stator coils can be aligned to the alignment jig, so the alignment quality of the I-type stator coils can be improved.

In addition, the effects that can be obtained or expected from various implementations are directly or implicitly disclosed in the detailed description of the various implementations. That is, various effects predicted will be disclosed in the detailed description to be provided later.

### BRIEF DESCRIPTION OF THE DRAWINGS

Since these drawings are for reference in explaining various implementations, the technical ideas of the present disclosure should not be interpreted as limited to the attached drawings.

FIG. 1 is a perspective view illustrating an example of an aligning apparatus for a hairpin type stator coil.

FIG. 2 is a side view illustrating the aligning apparatus.

FIG. 3 is a perspective view illustrating an example of a storage and a storage stacking portion applied to the aligning apparatus.

FIG. 4 is a side view illustrating the storage and the storage stacking portion.

FIG. 5 is a perspective view illustrating an example of a storage door and a storage door opening/closing module of the storage.

FIG. 6 is a front view illustrating the storage door and the storage door opening/closing module.

FIG. 7 to FIG. 9 are perspective views illustrating an example of a cartridge.

FIG. 10 is a side view illustrating the cartridge.

FIG. 11 is a front view illustrating the cartridge.

FIG. 12 and FIG. 13 are partial perspective views illustrating the cartridge.

FIG. 14 is a perspective view illustrating an example of a robot gripper.

FIG. 15 is a side view illustrating the robot gripper.

FIG. 16 is an exploded perspective view illustrating an example of gripper bodies of the robot gripper.

FIG. 17 to FIG. 19 are drawings illustrating an example of an alignment jig.

FIG. 20 is a perspective view illustrating an example of a coil pocket unit.

FIG. 21 is a perspective view illustrating an example of a pocket moving unit.

FIG. 22 is a perspective view illustrating an example of an alignment assist unit.

FIG. 23 is a perspective view illustrating an example of a coil extension part of the alignment assist unit.

FIG. 24 is a perspective view illustrating an example of a jig support part of the alignment assist unit.

FIG. 25 is a perspective view illustrating an example of a coil detector of the alignment assist unit.

### DETAILED DESCRIPTION

Hereinafter, with reference to the attached drawings, various implementations will be described in detail so that a person having ordinary skill in the art to which the present disclosure pertains can easily practice the present disclosure. As those skilled in the art would realize, the described various implementations can be modified in various different ways, all without departing from the spirit or scope of the present disclosure.

In the present application, the terms ‘vehicle’, ‘vehicular’, ‘automobile’ or other similar terms used herein generally include passenger automobiles, including passenger cars, sports utility vehicles (SUVs), buses, trucks, and various commercial vehicles, which can include hybrid automobiles equipped with high-voltage batteries, electric automobiles, hybrid electric vehicles, electric vehicle-based Purpose Built Vehicles (PBVs), and hydrogen-powered vehicles (also commonly referred to by those skilled in the art as ‘hydrogen electric vehicles’).

Hereinafter, various implementations will be described in detail with reference to the attached drawings.

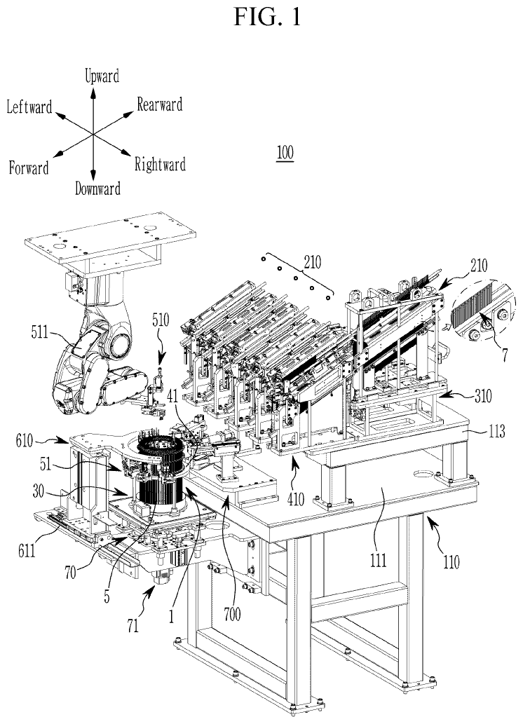

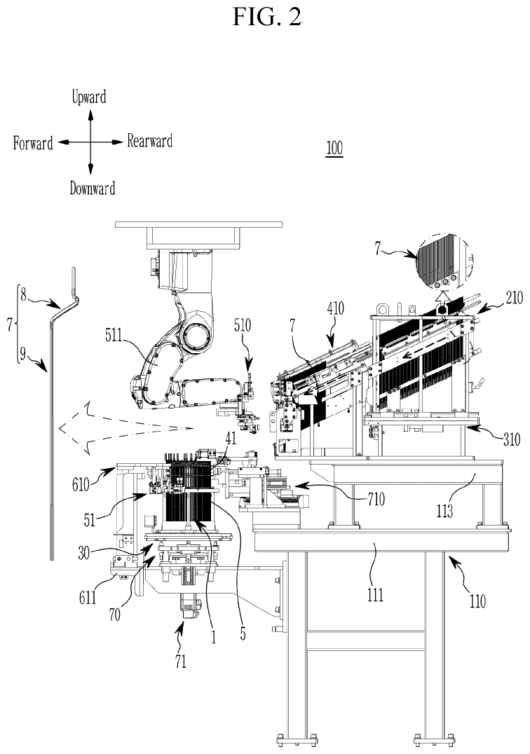

FIG. 1 is a perspective view illustrating an aligning apparatus for a hairpin type stator coil, and FIG. 2 is a side view illustrating an aligning apparatus for a hairpin type stator coil.

Referring to FIG. 1 and FIG. 2, in some implementations, an aligning apparatus for a hairpin type stator coil 100, can be applied to a process for manufacturing a hairpin winding type stator.

The hairpin winding type stator can be applied to environment-friendly vehicles that obtain driving torque with electrical energy, such as drive motors for hybrid vehicles and/or electric vehicles.

The stator is wound with a plurality of stator coils 1 formed in a hairpin type. A person of ordinary skill in the art can call the stator coils 1, also commonly called conductor coils, segment coils or square coils.

In one example, the stator coils 1 can include U-shaped stator coils 5 formed into a U-shaped hairpin type and I-shaped stator coils 7 formed into an I-shaped hairpin type.

The U-shaped stator coils 5 and the I-shaped stator coils 7 can be formed in the shape of a square cross-section. The I-shaped stator coils 7 can include, as shown in FIG. 2, a head part 8 and a leg part 9 extending from the head part 8.

The aligning apparatus for a hairpin type stator coil 100 can be applied to a process of inserting the stator coils 1 into a stator core of a stator.

The aligning apparatus for a hairpin type stator coil 100 is configured to separately align (or quasi-align) the stator coils 1 prior to the process of inserting the stator coils 1 into the stator core.

The aligned stator coils 1 are clamped by a clamper and can be inserted into the stator core by the clamper.

In this specification, the reference direction for describing the components below is set as front-rear direction, left-right direction, and vertical direction when referring to the drawing.

In this specification, the ‘upper portion’, ‘upper end’, or ‘upper face’ of a component indicates an end, section, or face of the component that is relatively higher in the drawing, and the ‘lower portion’, ‘lower end’, or ‘lower face’ of a component indicates an end, section, section, or face of the component that is relatively lower in the drawing.

In this specification, the term “end” of a component (e.g., one end or the other end, etc.) refers to an end of the component in any direction, and the term “part” or “portion” of a component (e.g., one end or the other end, etc.) refers to a portion of the component that includes that end.

The aligning apparatus for a hairpin type stator coil 100 is configured to align (or insert) stator coils 1 into an alignment jig 30 that is transported in a predetermined transport direction (e.g., left-right direction) via a conveyor.

Furthermore, the aligning apparatus for a hairpin type stator coil 100 is configured to automatically align I-shaped stator coils 7 to the alignment jig 30 to which the U-shaped stator coils 5 are aligned.

The configuration and operation of the alignment jig 30 as described above will be described in detail later.

The aligning apparatus for a hairpin type stator coil 100 includes a frame 110, at least one storage 210, at least one cartridge 410, a robot gripper 510, and an alignment assist unit 710.

In some implementations, the frame 110 can be fixed to the floor surface of the process workpiece or can be provided to be movable to any position on the floor surface.

The frame 110 is configured to mount various components that will be described below. The frame 110 can be composed of one frame or two or more partitioned frames.

The frame 110 can include various auxiliary elements such as brackets, bars, rods, plates, housings, cases, blocks, and barrier ribs that are designed to support each component.

However, since the various accessory elements described above are for mounting each component to be described below to the frame 110, in some implementations, the various accessory elements described above are collectively referred to as the frame 110.

The frame 110 includes a base frame 111 and a mount frame 113 mounted on the base frame 111.

The at least one storage 210 is configured to load (or store) a predetermined number of I-shaped stator coils 7. A person of ordinary skill in the art is also called the storage 210 magazine.

The at least one storage 210 can be provided in multiples. Each of the plurality of storages 210 can load I-shaped stator coils 7 of different shapes.

The at least one storage 210 can be placed in a storage stacking portion 310 installed in the mount frame 113. The storage stacking portion 310 is configured to load at least one storage 210.

The at least one storage 210 can be loaded into or unloaded from the storage stacking portion 310 by a storage loading unit that is movable in multiple directions.

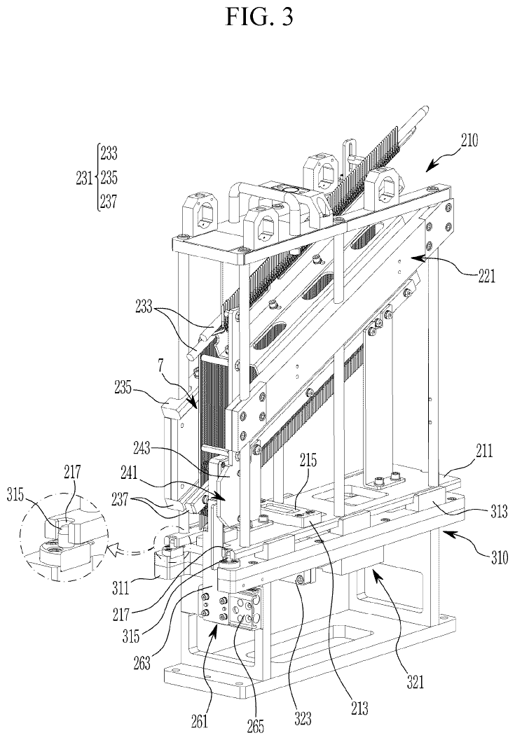

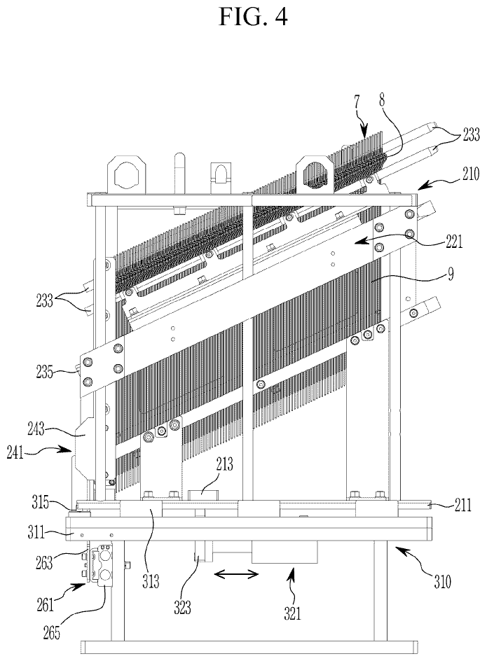

FIG. 3 is a perspective view illustrating a storage and a storage stacking portion, and FIG. 4 is a side view illustrating a storage and a storage stacking portion.

Referring to FIG. 3 and FIG. 4, the storage stacking portion 310 includes a stack base 311 and a storage docking cylinder 321.

The stack base 311 is provided in the form of a frame and is fixed to a mount frame 113 (see FIG. 1 and FIG. 2).

The storage docking cylinder 321 is configured to move at least one storage 210 along the front-rear direction on the stack base 311. The storage docking cylinder 321 is configured to dock at least one storage 210 to at least one cartridge 410 (see FIG. 1 and FIG. 2) described below, or to undocking from at least one cartridge 410.

The storage docking cylinder 321 is installed on the stack base 311 and is operationally connected to at least one storage 210.

The storage docking cylinder 321 may, in one example, include a pneumatic cylinder. The storage docking cylinders 321 include a docking block 323 that is movable forward and backward along the front-rear direction. The docking block 323 can be connected to at least one storage 210.

Referring to FIG. 3 and FIG. 4, the at least one storage 210 includes a storage base 211, a storage body 221, a plurality of storage guides 231, a storage door 241, and a storage door driver 261.

The storage base 211 is placed below at least one storage 210 and is provided in a plate shape.

The storage base 211 is movably connected to the stack base 311 in the front-rear direction. The storage base 211 is movably connected in the front-rear direction to a plurality of rail blocks 313 provided on the stack base 311.

In some examples, the storage base 211 is connected to the docking block 323 of the storage docking cylinder 321. Here, the docking block 323 is connected to a connecting block 213 provided in the storage base 211. The docking block 323 is fitted into a connecting hole 215 formed in the connecting block 213.

A pair of storage docking pins 315 are mounted on the front portion of the stack base 311. The storage docking pins 315 can function as a docking stopper that determines the docking position of at least one storage 210 and at least one cartridge 410 (see FIG. 1 and FIG. 2).

The storage docking pins 315 can be connected to pin joint grooves 217 formed in the front portion of the storage base 211 when at least one storage 210 is moved forward on the stack base 311 by operation of the storage docking cylinder 321.

The storage body 221 is fixed to the storage base 211. The storage body 221 can be composed of a combination of a plurality of rods, a plurality of plates, and a plurality of blocks mounted on the storage base 211.

The storage guides 231 are configured to load a predetermined number of the I-shaped stator coils 7 along the front-rear direction.

The storage guides 231 are mounted along the front-rear direction in the storage body 221. The storage guides 231 are arranged so as to slope downward from the rear to the front.

The storage guides 231 can include, in one example, a pair of storage guide bars 233 arranged at an upper portion of the storage body 221, a first storage guide plate 235 arranged at a middle portion of the storage body 221, and a pair of second storage guide plates 237 arranged at a lower portion of the storage body 221.

The storage guide bars 233 can guide the movement the head part 8 of the I-shaped stator coils 7. The first storage guide plate 235 and the second storage guide plates 237 can guide the movement of the leg part 9 of the I-shaped stator coils 7.

The storage door 241 is configured to support I-shaped stator coils 7 which are loaded onto the storage guides 231. That is, the storage door 241 is configured to prevent the I-shaped stator coils 7 loaded on the storage guides 231 from sliding from rear to front.

The storage door 241 is configured to extract the I-shaped stator coils 7 loaded on the storage guides 231 into at least one cartridge 410 (see FIG. 1 and FIG. 2) to be described later.

The storage door 241 is installed on the front portion of the storage body 221.

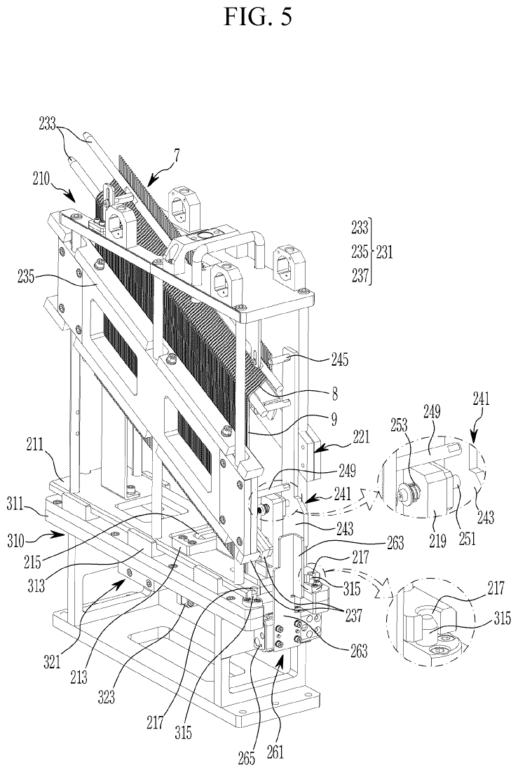

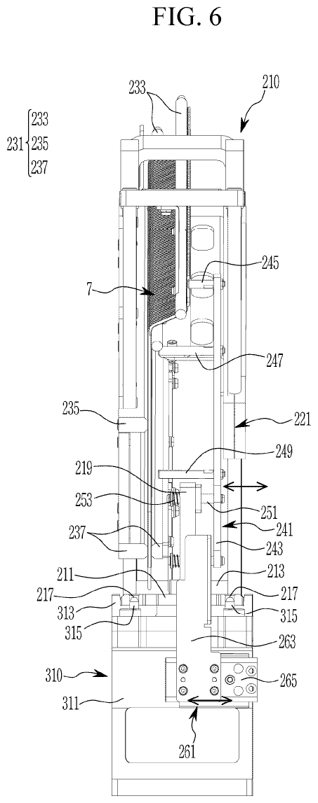

FIG. 5 is a perspective view illustrating a storage door and a storage door opening/closing module of a storage, and FIG. 6 is a front view illustrating a storage door and a storage door opening/closing module of a storage.

Referring to FIG. 3 to FIG. 6, the storage door 241 includes a door plate 243, an upper storage stopper 245, a medium storage stopper 247, and a lower storage stopper 249.

The door plate 243 is arranged along the vertical direction on one side of the front portion of the storage body 221. The door plate 243 is mounted movably in the left-right direction on a door mount block 219 that is fixed in the vertical direction to the storage base 211.

The door plate 243 can be movably mounted in the left-right direction to the door mount block 219 via at least one mount rod 251. A spring 253 can be placed between the mount rod 251 and the door mount block 219. The spring 253 can elastically support the door plate 243.

The upper storage stopper 245 is mounted on the upper part of the door plate 243 and is arranged along the left-right direction. The upper storage stopper 245 is provided in a rod shape and is configured to support the head part 8 of the I-shaped stator coils 7.

The medium storage stopper 247 is mounted in the middle of the door plate 243 and is positioned along the left-right direction. Additionally, the lower storage stopper 249 is mounted at the lower portion of the door plate 243 and is positioned along the left-right direction.

The medium storage stopper 247 and the lower storage stopper 249 are provided in a rod shape and are configured to support the leg part 9 of the I-shaped stator coils 7.

Referring to FIG. 3 to FIG. 6, the storage door driver 261 is configured to selectively open and close the storage door 241.

The storage door driver 261 is installed on the front portion of the stack base 311 at a position corresponding to the door plate 243 of the storage door 241.

The storage door driver 261 includes a door operating bracket 263 and a storage door operating cylinder 265.

The door operating bracket 263 is configured to move the door plate 243 in the left-right direction. The door operating bracket 263 is mounted movably in the left-right direction on the front portion of the stack base 311.

The storage door operating cylinder 265 is installed on the front portion of the stack base 311 and is operationally connected to the door operating bracket 263.

The storage door operating cylinder 265 can include, in one example, a pneumatic cylinder.

When the storage door operating cylinder 265 operates forward and backward in the left-right direction, the door operating bracket 263 can move the door plate 243 in the left-right direction.

When the door plate 243 is moved in one direction by the door operating bracket 263, the upper storage stopper 245, the medium storage stopper 247, and the lower storage stopper 249 can release the stopping of the I-shaped stator coils 7 loaded on the storage guides 231. In this case, the I-shaped stator coils 7 can be withdrawn from the storage body 221 via the storage guides 231.

In some examples, when the door plate 243 is moved in the other direction by the door operating bracket 263 and the elastic force of the spring 253, the upper storage stopper 245, the medium storage stopper 247, and the lower storage stopper 249 can prevent the sliding of the I-shaped stator coils 7 loaded on the storage guides 231.

Referring to FIG. 1 and FIG. 2, in some implementations, the at least one cartridge 410 is configured to load I-shaped stator coils 7 taken out from at least one storage 210, and to take out the I-shaped stator coils 7 one by one.

The at least one cartridge 410 is positioned in front of the at least one storage 210 on the mount frame 113.

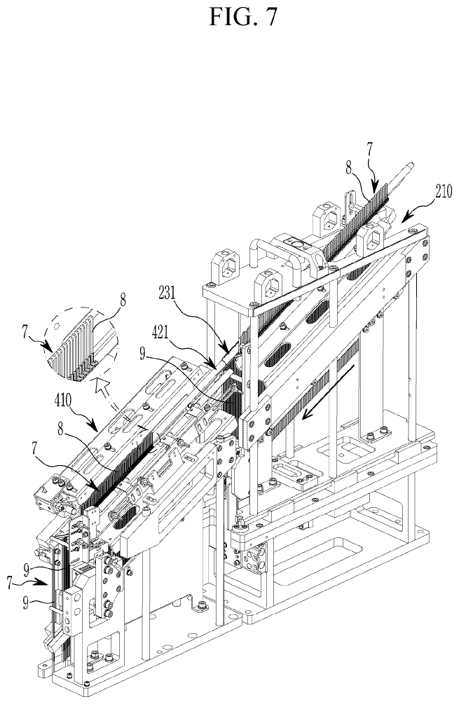

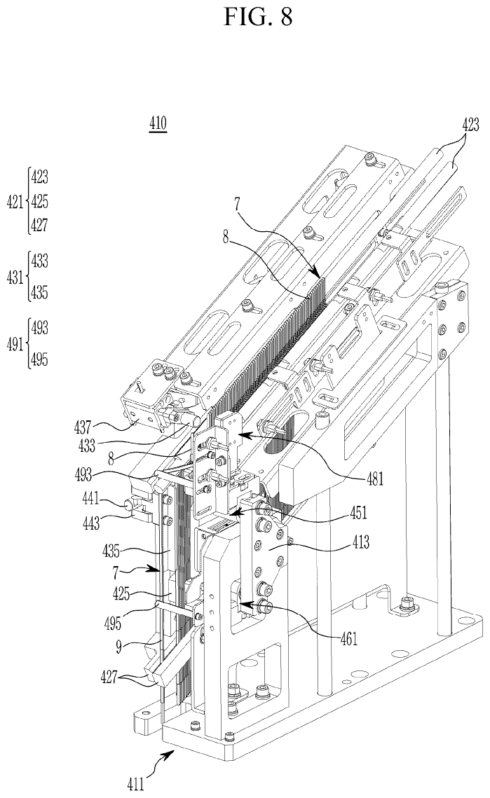

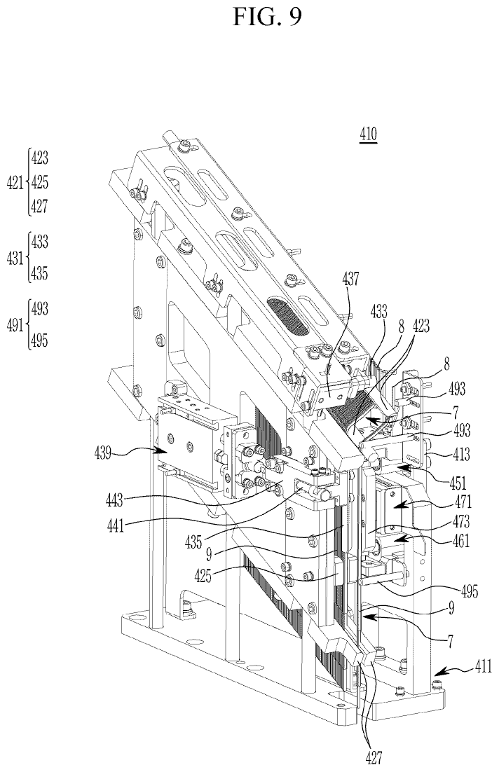

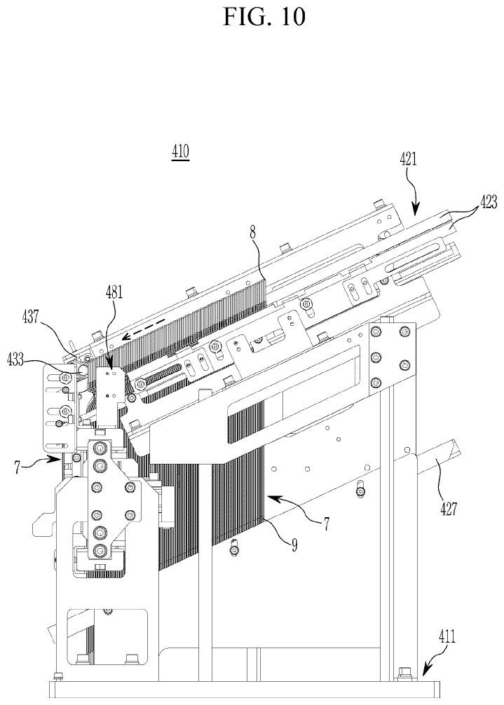

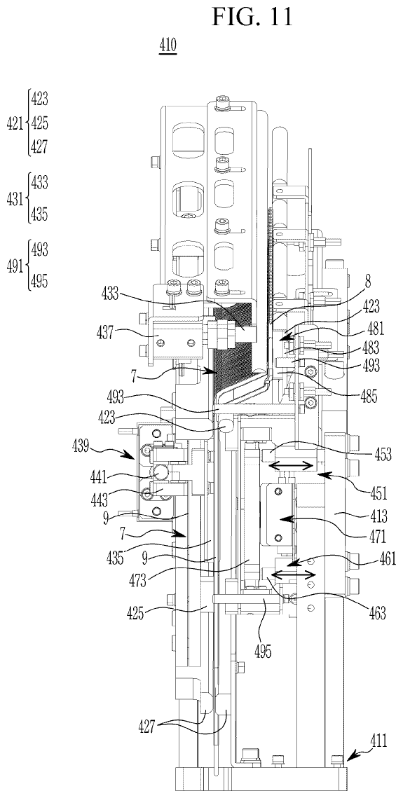

FIG. 7 to FIG. 9 are perspective views illustrating a cartridge, FIG. 10 is a side view illustrating a cartridge, and FIG. 11 is a front view illustrating a cartridge. Referring to FIG. 7 to FIG. 11, the at least one cartridge 410 includes a cartridge body 411, a plurality of cartridge guides 421, a main stopper 431, an upper stopper block assembly 451, a lower stopper block assembly 461, a sub-stopper driving cylinder 471, a coil clamper 481, and a sub-stopper 491.

The cartridge body 411 is installed in a mount frame 113 (see FIG. 1 and FIG. 2).

The cartridge guides 421 are configured to load the I-shaped stator coils 7 extracted from at least one storage 210 along the front-rear direction.

The cartridge guides 421 are mounted along the front-rear direction in the cartridge body 411. The cartridge guides 421 are arranged so as to slope downward from the rear to the front. The cartridge guides 421 can be connected along the front-rear direction with the storage guides 231 of at least one storage 210.

The cartridge guides 421 can include, in one example, a pair of cartridge guide bars 423 arranged at an upper portion of the cartridge body 411, a first cartridge guide plate 425 arranged at a middle portion of the cartridge body 411, and a pair of second cartridge guide plates 427 arranged at a lower portion of the cartridge body 411.

The cartridge guide bars 423 can guide the movement of the head part 8 of the I-shaped stator coils 7. The first cartridge guide plate 425 and the second cartridge guide plates 427 can guide the movement of the leg part 9 of the I-shaped stator coils 7.

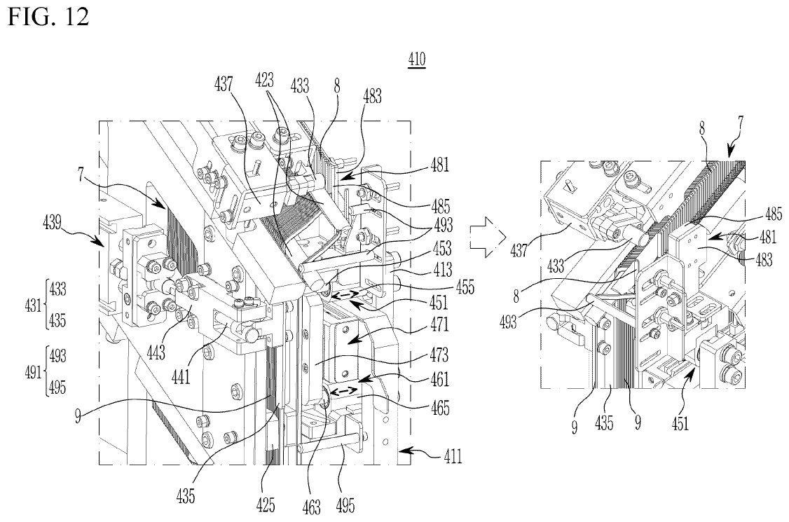

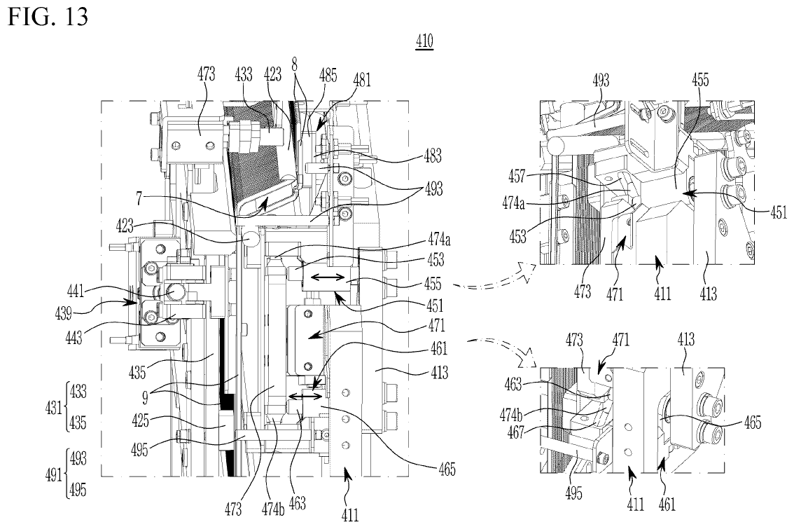

FIG. 12 and FIG. 13 are partial perspective views illustrating a cartridge. Referring to FIG. 7 to FIG. 13, the main stopper 431 is configured to support I-shaped stator coils 7 which are loaded on cartridge guides 421. That is, the main stopper 431 is configured to prevent the I-shaped stator coils 7 loaded on the cartridge guides 421 from sliding from rear to front.

The main stopper 431 is installed on the front portion of the cartridge body 411.

The main stopper 431 includes a head stopper 433 and a leg stopper 435.

The head stopper 433 is configured to support the head part 8 of the I-shaped stator coils 7 which are loaded onto the cartridge guides 421.

The head stopper 433 is operationally connected to an upper main driving cylinder 437 installed in the cartridge body 411. The upper main driving cylinder 437 may, in one example, include a pneumatic cylinder.

The head stopper 433 can be provided in rod form. The head stopper 433 moves forward in the left-right direction by the forward operation of the upper main driving cylinder 437 and can support the head part 8 of the I-shaped stator coils 7. In some examples, the head stopper 433 moves backward in the left-right direction by the backward operation of the upper main driving cylinder 437, and can release the stopping of the head part 8 of the I-shaped stator coils 7.

The leg stopper 435 is configured to support the leg part 9 of the I-shaped stator coils 7 which are loaded onto the cartridge guides 421.

The leg stopper 435 is operationally connected to a lower main driving cylinder 439 installed in the cartridge body 411. The lower main driving cylinder 439 may, in one example, include a pneumatic cylinder.

The leg stopper 435 can be provided in the form of a plate arranged along the vertical direction. The leg stopper 435 is linked to an operation rod 441 of the lower main driving cylinder 439.

The operation rod 441 is connected to a stopper mount block 443 fixed to the cartridge body 411 so as to be movable in the front-rear direction. The leg stopper 435 is hinge-connected to the stopper mount block 443 and link-connected to an end of the operation rod 441.

The leg stopper 435 can support the leg part 9 of the I-shaped stator coils 7 by swinging and rotating rearwardly as the operation rod 441 moves forward through the stopper mount block 443 by the forward operation of the lower main driving cylinder 439.

The leg stopper 435 can release the stopping of the leg part 9 of the I-shaped stator coils 7 by swinging forward and rotating as the operation rod 441 moves backward through the stopper mount block 443 by the backward operation of the lower main driving cylinder 439.

The upper stopper block assembly 451 and the lower stopper block assembly 461 are mounted movably in the left-right direction on the front portion of the cartridge body 411. The upper stopper block assembly 451 is positioned at the upper portion of the cartridge body 411, and the lower stopper block assembly 461 is positioned at the lower portion of the upper stopper block assembly 451.

The upper stopper block assembly 451 is composed of a combination of blocks and is mounted on a fixing block 413 fixed to the cartridge body 411 so as to be movable in the left-right direction.

The upper stopper block assembly 451 is connected to an upper guide shaft 453 mounted on the fixing block 413 so as to be movable in the left-right direction. The upper guide shaft 453 is fitted along the left-right direction into an upper bushing block 455 provided in the upper stopper block assembly 451.

The lower stopper block assembly 461 is composed of a combination of blocks and is mounted on the fixing block 413 so as to be movable in the left-right direction.

The lower stopper block assembly 461 is connected to a lower guide shaft 463 mounted on the fixing block 413 so as to be movable in the left-right direction. The lower guide shaft 463 is inserted along the left-right direction into a lower bushing block 465 provided in the lower stopper block assembly 461.

The sub-stopper driving cylinder 471 is configured to move the upper stopper block assembly 451 and the lower stopper block assembly 461 in the left-right direction.

The sub-stopper driving cylinder 471 is installed in the cartridge body 411 and is positioned between the upper stopper block assembly 451 and the lower stopper block assembly 461.

The sub-stopper driving cylinder 471 is operationally connected to the upper stopper block assembly 451 and the lower stopper block assembly 461. The sub-stopper driving cylinder 471 may, in one example, include a pneumatic cylinder.

The sub-stopper driving cylinder 471 includes a stopper driving block 473 that can move forward and backward in the front-rear direction. The stopper driving block 473 can be connected to the upper stopper block assembly 451 and the lower stopper block assembly 461 through the upper and lower portions.

As shown in FIG. 13, the stopper driving block 473 includes an upper cam protrusion 474a formed at the upper portion and a lower cam protrusion 474b formed at the lower portion.

Additionally, the upper stopper block assembly 451 includes a slot-shaped upper cam follower 457, and the lower stopper block assembly 461 includes a slot-shaped lower cam follower 467.

The upper cam follower 457 is formed diagonally along the front-rear direction in the upper stopper block assembly 451. The lower cam follower 467 is formed diagonally along the front-rear direction in the lower stopper block assembly 461.

The upper cam protrusion 474a of the stopper driving block 473 is inserted into the upper cam follower 457, and the lower cam protrusion 474b of the stopper driving block 473 is inserted into the lower cam follower 467.

When the stopper driving block 473 moves forward by the operation of the sub-stopper driving cylinder 471, the upper cam protrusion 474a is guided along the upper cam follower 457, and the upper stopper block assembly 451 can move forward along the left-right direction.

At the same time, when the stopper driving block 473 moves forward by the operation of the sub-stopper driving cylinder 471, the lower cam protrusion 474b is guided along the upper cam follower 457, and the lower stopper block assembly 461 can move forward along the left-right direction.

In addition, when the stopper driving block 473 moves backward by the operation of the sub-stopper driving cylinder 471, the upper stopper block assembly 451 and the lower stopper block assembly 461 can move backward along the left-right direction.

The coil clamper 481 is configured to clamp the I-shaped stator coils 7 arranged at the rear of the frontmost I-shaped stator coil 7 among the I-shaped stator coils 7 loaded on the cartridge guides 421.

That is, the coil clamper 481 can clamp or unclamp some of the I-shaped stator coils 7 arranged at the rear of the frontmost I-shaped stator coil 7, leaving the frontmost I-shaped stator coil 7.

The coil clamper 481 is mounted on the upper stopper block assembly 451. The coil clamper 481 is connected to a clamper bracket 483 fixed to the upper part of the upper stopper block assembly 451. The coil clamper 481 includes a clamping pad 485 configured to clamp or unclamp the I-shaped stator coils 7.

The coil clamper 481 can clamp the I-shaped stator coils 7 by causing the upper stopper block assembly 451 to move forward along the left-right direction. In some examples, the coil clamper 481 can unclamp the I-shaped stator coils 7 by causing the upper stopper block assembly 451 to move backward along the left-right direction.

The sub-stopper 491 is configured to support and extract the frontmost I-shaped stator coil 7 as mentioned above. That is, the sub-stopper 491 can prevent sliding of the frontmost I-shaped stator coil 7 or release the stopping of the frontmost I-shaped stator coil 7.

The sub-stopper 491 is mounted on the upper stopper block assembly 451 and the lower stopper block assembly 461.

The sub-stopper 491 includes at least one upper cartridge stopper 493 and at least one lower cartridge stopper 495.

The at least one upper cartridge stopper 493 is configured to support the head part 8 of the frontmost I-shaped stator coil 7. The at least one upper cartridge stopper 493 is mounted on the upper stopper block assembly 451 and is arranged along the left-right direction.

In one example, the at least one upper cartridge stopper 493 can be provided as a pair. The pair of upper cartridge stoppers 493 are arranged along the vertical direction in the upper stopper block assembly 451.

The at least one lower cartridge stopper 495 is provided to support leg part 9 of the frontmost I-shaped stator coil 7. The at least one lower cartridge stopper 495 is mounted on the lower stopper block assembly 461 and is arranged along the left-right direction.

When the upper stopper block assembly 451 and the lower stopper block assembly 461 move forward along the left-right direction, at least one upper cartridge stopper 493 and at least one lower cartridge stopper 495 can prevent sliding of the frontmost I-shaped stator coil 7.

In some examples, when the upper stopper block assembly 451 and the lower stopper block assembly 461 move backward along the left-right direction, at least one upper cartridge stopper 493 and at least one lower cartridge stopper 495 can release the stopping of the frontmost I-shaped stator coil 7. In this case, the frontmost I-shaped stator coil 7 can be withdrawn from the cartridge body 411 via the cartridge guides 421.

Referring to FIG. 1 and FIG. 2, in some implementations, the robot gripper 510 is configured to grip and release I-shaped stator coils 7 extracted one by one from at least one cartridge 410 and insert them into predetermined positions in the alignment jig 30.

The robot gripper 510 is equipped to be moved along a predetermined path by a handling robot 511.

The handling robot 511 is installed in the process work area. The handling robot 511 can include a multi-joint robot known to a person of ordinary skill in the art to move the robot along a predetermined teaching path within a work radius.

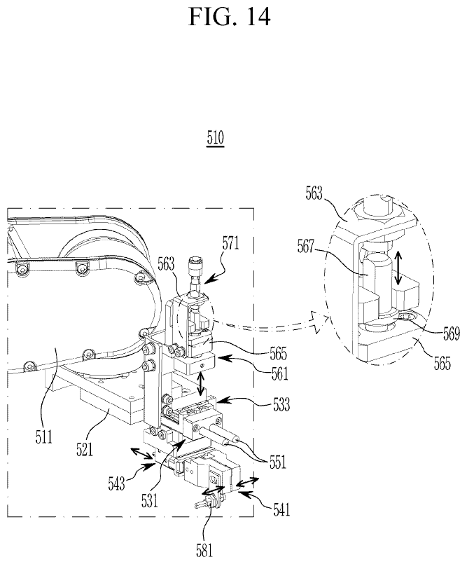

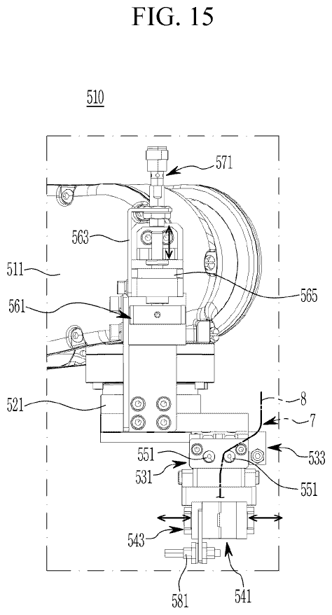

FIG. 14 is a perspective view illustrating a robot gripper, and FIG. 15 is a side view illustrating a robot gripper.

Referring to FIG. 14 and FIG. 15, the robot gripper 510 includes a mounting bracket 521, a moving block 531, a pair of gripper bodies 541, a pair of coil guide pins 551, a sensor dog block 561, and a proximity sensor 571.

The mounting bracket 521 is mounted on an end of the arm of the handling robot 511.

The moving block 531 is provided to be able to move forward and backward by the operation of a gripper sub-driving cylinder 533 installed in the mounting bracket 521. In one example, the gripper sub-driving cylinder 533 can include a pneumatic cylinder.

The moving block 531 is operationally connected to the gripper sub-driving cylinder 533, and can move forward and backward through the guide mechanism by the operation of the gripper sub-driving cylinder 533.

The gripper bodies 541 are configured to grip or release the I-shaped stator coil 7.

The gripper bodies 541 are provided to be able to move in a direction toward or away from each other by the operation of a gripper main driving cylinder 543 installed in the moving block 531. In one example, the gripper main driving cylinder 543 can include a pneumatic cylinder.

The gripper bodies 541 are operationally connected to the gripper main driving cylinder 543 and can move in a direction toward or away from each other through a guide mechanism by operation of the gripper main driving cylinder 543.

The gripper bodies 541 can be moved forward and backward through the moving block 531 that moves forward and backward by the operation of the gripper sub-driving cylinder 533.

The gripper bodies 541 can be moved forward through the moving block 531 by the operation of the gripper sub-driving cylinder 533 when gripping the I-shaped stator coil 7.

In some examples, the gripper bodies 541 can be moved backwards through the moving block 531 by the operation of the gripper sub-driving cylinder 533 after the releasing of the I-shaped stator coil 7.

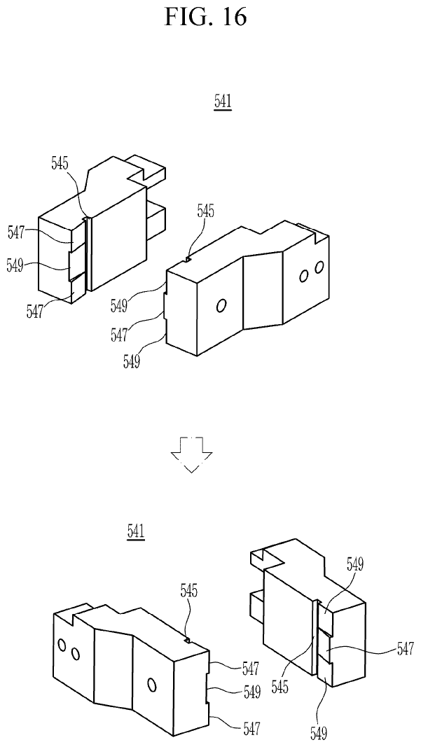

FIG. 16 is an exploded perspective view illustrating gripper bodies of a robot gripper.

Each of the gripper bodies 541 includes, as shown in FIG. 16, a gripping groove 545, at least one gradient protrusion 547, and at least one gradient groove portion 549.

The gripping groove 545 is formed, in one example, as a groove with a ‘U’ cross-section shape on each of the gripper bodies 541. The gripping groove 545 is formed along the vertical direction on the gripping surface of the gripper bodies 541.

The at least one gradient protrusion 547 and the at least one gradient groove portion 549 are formed so as to overlap each other on the gripping surfaces of the gripper bodies 541 and are connected to the gripping groove 545.
the at least one gradient protrusion 547 may, in one example, be formed in the form of a taper protrusion on the gripping surface of the gripper bodies 541.

At least one gradient protrusion 547 can be formed spaced apart along the vertical direction on the gripping surface of one of the gripper bodies 541. Additionally, the at least one gradient protrusion 547 can be formed on a gripping surface of another one of the gripper bodies 541.

In some examples, the at least one gradient groove portion 549 can be formed in a taper groove shape on the gripping surface of the gripper bodies 541, in one example. The at least one gradient groove portion 549 can be connected to overlap with at least one gradient protrusion 547.

The at least one gradient groove portion 549 can be formed between the gradient protrusions 547 on the gripping surface of one of the gripper bodies 541.

Additionally, the at least one gradient groove portion 549 can be formed on the upper and lower sides of the other gripping surface of the gripper bodies 541, with the gradient protrusion 547 therebetween.

Therefore, when the gripper bodies 541 grip the I-shaped stator coil 7, even if the I-shaped stator coil 7 is out of the gripping groove 545, the I-shaped stator coil 7 can be guided into the gripping groove 545 by overlapping at least one gradient protrusion 547 and at least one gradient groove portion 549.

Accordingly, despite the various position dispersions of the I-shaped stator coil 7, the gripper bodies 541 can smoothly grip the I-shaped stator coil 7 through the gripping groove 545.

Referring to FIG. 14 and FIG. 15, the coil guide pins 551 are mounted on the moving block 531. The coil guide pins 551 are arranged along the forward and backward moving direction of the moving block 531.

The coil guide pins 551 can support the head part 8 of the I-shaped stator coil 7 when the I-shaped stator coil 7 is released by the gripper bodies 541.

When the I-shaped stator coil 7 is released by the gripper bodies 541, the I-shaped stator coil 7 falls freely. At this time, if the head part 8 of the I-shaped stator coil 7 is caught by the gripper bodies 541, interference can occur between the gripper bodies 541 and the I-shaped stator coil 7 when the gripper bodies 541 move backward.

In some examples, since the coil guide pins 551 serve as stoppers that support the head part 8 of the I-shaped stator coil 7, the gripper bodies 541 can be prevented from interfering with the I-shaped stator coil 7.

The sensor dog block 561 is mounted movably in the vertical direction on the fixing bracket 563 which is secured to the mounting bracket 521.

When the gripper bodies 541 gripping the I-shaped stator coil 7 descend, if the I-shaped stator coil 7 hits an obstacle (e.g., other stator coils), the I-shaped stator coil 7 can slip in an upward direction between the gripper bodies 541.

The sensor dog block 561 can be moved upwards by the I-shaped stator coil 7 that slides upwards.

These sensor dog blocks 561 can be connected to a dog support block 565 fixed to the fixing bracket 563 so as to be movable in the vertical direction. The sensor dog block 561 can be connected to a bushing rod 567 passing through the dog support block 565 in a vertical direction.

The bushing rod 567 can be supported on the dog support block 565 by the stopper flange 569. Additionally, the sensor dog block 561 can be moved downward by its own weight through the bushing rod 567.

The proximity sensor 571 is configured to detect upward movement of the sensor dog block 561. The proximity sensor 571 is installed in the fixing bracket 563 on the upper side corresponding to the sensor dog block 561.

The proximity sensor 571 is a sensor that can detect when an object approaches within a predetermined distance, and since it is well known to a person of ordinary skill in the art, further detailed description will be omitted.

In some examples, a coil detecting sensor 581 can be installed in one of the gripper bodies 541. The coil detecting sensor 581 can detect the I-shaped stator coil 7 gripped by the gripper bodies 541.

Referring to FIG. 1 and FIG. 2, the alignment jig 30 can be transported along a predetermined transport direction via a conveyor. The alignment jig 30 can be docked and connected to the jig docking part 70 installed on the base frame 111 at a predetermined docking point of the conveyor.

The jig docking part 70 can move in the vertical direction by the operation of the docking driver 71 and be docked connected with the alignment jig 30. The jig docking part 70 can apply torque to the alignment jig 30 by operation of the docking driver 71.

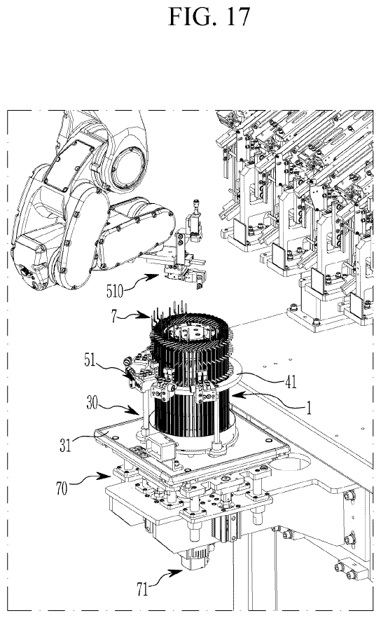

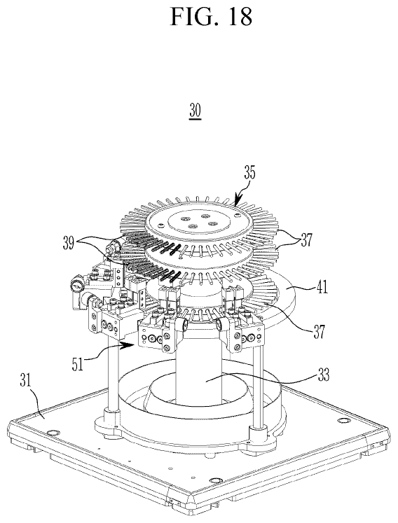

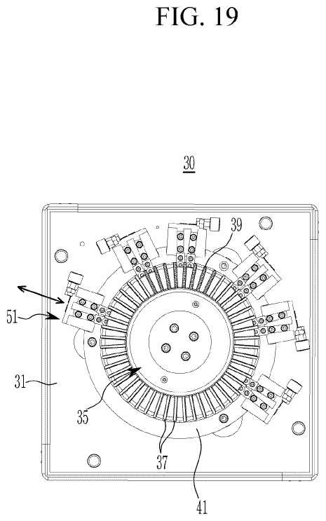

FIG. 17 to FIG. 19 are drawings illustrating an alignment jig.

Referring to FIG. 17 to FIG. 19, the alignment jig 30 includes a jig base 31, a rotation shaft 33, fixing rings 35, jig pins 37, jig springs 39, a support ring 41, and coil pocket units 51.

The jig base 31 can be connected to the jig docking part 70.

The rotation shaft 33 is rotatably mounted on the jig base 31. The rotation shaft 33 is operationally connected to the jig docking part 70 and can be rotated by receiving torque from the docking driver 71.

The fixing rings 35 are connected to the rotation shaft 33 at predetermined intervals along the vertical direction. The fixing rings 35 can be arranged in a plurality of stages (e.g., three stages) along the vertical direction of the rotation shaft 33.

The jig pins 37 are fixed to the exterior circumference surface of the fixing rings 35 and are arranged radially on the exterior circumference surface of the fixing rings 35 at predetermined intervals.

The jig pins 37 are configured to support the stator coils 1, and the separation space between the jig pins 37 can be defined as an insertion space into which the stator coils 1 are inserted.

The jig springs 39 can be provided as coil springs supporting the stator coils 1. The jig springs 39 are arranged radially in a predetermined exterior circumference section of the fixing rings 35.

The jig springs 39 can buffer the load acting on the stator coils 1 and form a space into which the stator coils 1 can be inserted.

The support ring 41 is secured to the jig base 31 with the fixing rings 35 placed inside.

The coil pocket units 51 are configured to guide the leg part 9 (see FIG. 2) of the I-shaped stator coil 7, which is inserted into predetermined positions of the jig pins 37 and the jig springs 39 by the operation of the robot gripper 510. The coil pocket units 51 are radially movably mounted on the support ring 41.

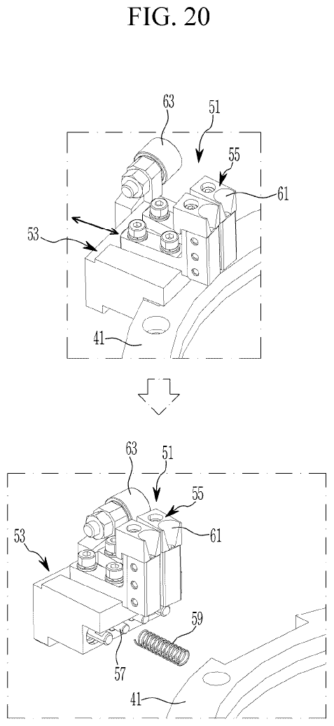

FIG. 20 is a perspective view illustrating a coil pocket unit.

Each of the coil pocket units 51, as shown in FIG. 20, includes a pocket block 53 and guide blocks 55.

The pocket block 53 is radially movably connected to the support ring 41. The pocket block 53 can be radially movably connected to the support ring 41 via guide rods 57.

A spring 59 is mounted on the guide rods 57. The spring 59 is placed between the pocket block 53 and the support ring 41 to support the pocket block 53 with elasticity.

The guide blocks 55 are connected to the pocket block 53. The guide blocks 55 include pocket guide holes 61 formed along the vertical direction.

The pocket guide hole 61 is configured to guide the leg part 9 of the I-shaped stator coil 7, which is inserted into the alignment jig 30.

The pocket guide hole 61 can be formed in a shape where the interior diameter gradually decreases from top to bottom. The pocket guide hole 61 can guide the leg part 9 of the I-shaped stator coil 7 to a predetermined position of the alignment jig 30 even if dispersion occurs in the insertion position of the I-shaped stator coil 7.

The coil pocket units 51 can be moved outwardly a by a pocket moving units 610 as shown in FIG. 1 and FIG. 2.

In some implementations, the pocket moving unit 610 makes cam contact with the coil pocket units 51 to avoid interference between the U-shaped stator coils 5 aligned on the alignment jig 30 and the coil pocket units 51, and can move the coil pocket units 51 outside the radius of the support ring 41.

The pocket moving unit 610 is installed on a base part 611 connected to the jig docking part 70.

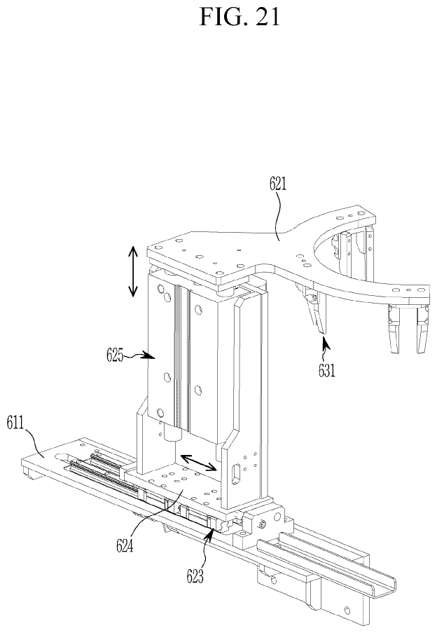

FIG. 21 is a perspective view illustrating a pocket moving unit.

As shown in FIG. 1, FIG. 2, FIG. 20, and FIG. 21, the pocket moving unit 610 includes a fixing plate 621 and cam blocks 631.

The fixing plate 621 is operationally connected to a first operating cylinder 623 installed on the base part 611. The fixing plate 621 can be moved forward and backward in the left-right direction (e.g., the transport direction of the alignment jig moving along the conveyor) by the operation of the first operation cylinder 623. In one example, the first operating cylinder 623 can include a pneumatic cylinder. The first operation cylinder 623 includes a first moving plate 624 that moves forward and backward along the left-right direction.

The fixing plate 621 is operationally connected to a second operation cylinder 625 installed on the first moving plate 624. The fixing plate 621 can be moved forward and backward in the vertical direction by the operation of the second operation cylinder 625. In one example, the second operation cylinder 625 can include a pneumatic cylinder.

The cam blocks 631 are configured to make cam contact with the coil pocket units 51. The cam blocks 631 can make cam contact along the vertical direction with a cam roller 63 rotatably mounted in the pocket block 53 of the coil pocket units 51.

The cam blocks 631 are mounted on the fixing plate 621 at positions corresponding to the pocket blocks 53. The cam blocks 631 may, in one example, be provided in the form of a wedge block.

The cam blocks 631 come into cam contact with the cam roller 63 as the fixing plate 621 moves in the vertical direction by the operation of the second operation cylinder 625, and can move the pocket block 53 outside the radius of the support ring 41.

Referring to FIG. 1 and FIG. 2, in some implementations, the alignment assist unit 710 is configured to assist insertion (or alignment) of the I-shaped stator coils 7 relative to the alignment jig 30.

The alignment assist unit 710 is installed on the base frame 111. The alignment assist unit 710 is placed in front of at least one cartridge 410. The alignment assist unit 710 is placed between at least one cartridge 410 and the alignment jig 30.

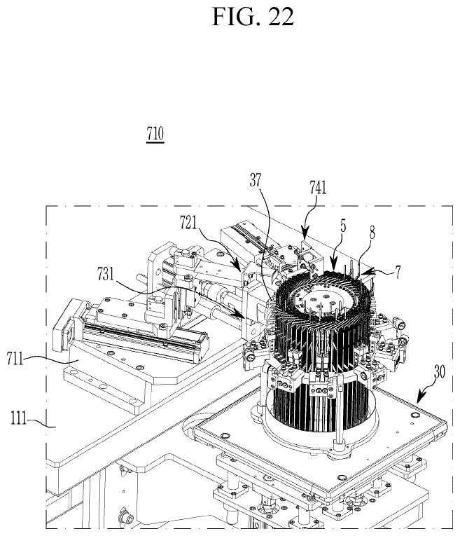

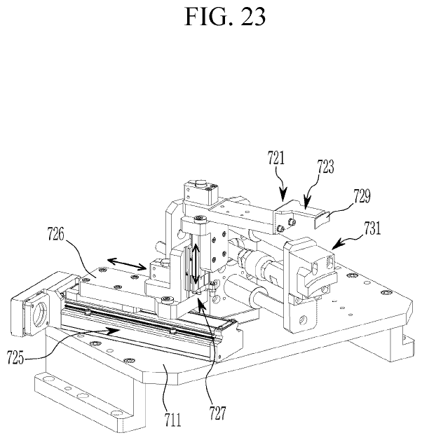

FIG. 22 is a perspective view illustrating an alignment assist unit, and FIG. 23 is a perspective view illustrating a coil extension part of an alignment assist unit.

Referring to FIG. 22 and FIG. 23, the alignment assist unit 710 includes a coil extension part 721, a jig supporter 731, and a coil detector 741.

The coil extension part 721, the jig supporter 731, and the coil detector 741 are installed on the base plate 711 fixed on the base frame 111 at positions corresponding to the alignment jig 30.

In some implementations, the coil extension part 721 is configured to pull the U-shaped stator coils 5 aligned to the alignment jig 30 outside a radius of the alignment jig 30. The coil extension part 721 is installed on the base plate 711. The coil extension part 721 includes a pull block 723.

The pull block 723 is operationally connected to a third operation cylinder 725 installed on the base plate 711. The pull block 723 can be moved forward and backward in the front-rear direction by the operation of the third operation cylinder 725. In one example, the third operation cylinder 725 can include a pneumatic cylinder. The third operating cylinder 725 includes a second moving plate 726 that moves forward and backward along the front-rear direction.

The pull block 723 is operationally connected to a fourth operation cylinder 727 installed on the second moving plate 726. The pull block 723 can be moved forward and backward in the vertical direction by the operation of the fourth operation cylinder 727. In one example, the fourth operation cylinder 727 can include a pneumatic cylinder.

The pull block 723 includes a pull finger 729 extending in a downward direction from the block body.

Referring to FIG. 22, in some implementations, the jig supporter 731 is configured to support the alignment jig 30 that moves by means of the coil extension part 721 when pulling the U-shaped stator coils 5 by the coil extension part 721. The jig supporter 731 is installed on the base plate 711.

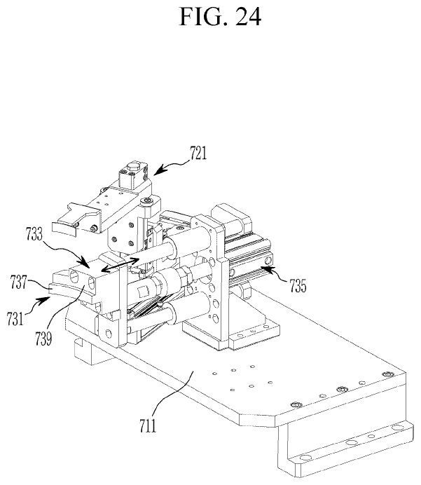

FIG. 24 is a perspective view illustrating a jig support part of an alignment assist unit.

The jig supporter 731 includes a jig support block 733, as shown in FIG. 22 and FIG. 24.

The jig support block 733 is operationally connected to a fifth operation cylinder 735 installed on the base plate 711. The jig support block 733 can be moved forward and backward in the front-rear direction at a position corresponding to the alignment jig 30 by the operation of the fifth operation cylinder 735. In one example, the fifth operation cylinder 735 can include a pneumatic cylinder.

The jig support block 733 includes a support protrusion 737 and a support surface 739 formed to support the jig pins 37 of the alignment jig 30. The support protrusion 737 and the support surface 739 are spaced apart from the jig pins 37 at a predetermined spacing.

Referring to FIG. 22, in some implementations, the coil detector 741 is configured to detect the I-shaped stator coils 7 inserted into the alignment jig 30. The coil detector 741 is installed on the base plate 711.

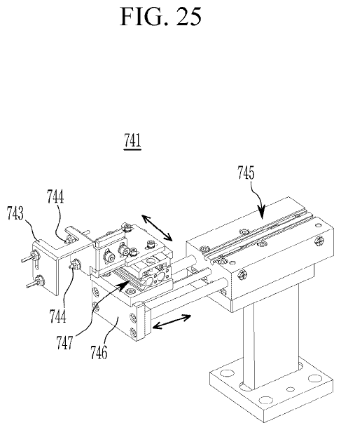

FIG. 25 is a perspective view illustrating a coil detector of an alignment assist unit.

The coil detector 741 includes a sensor block 743, and a pair of head detecting sensors 744 as shown in FIG. 22 and FIG. 25.

The sensor block 743 is operationally connected to a sixth operation cylinder 745 installed on the base plate 711. The sensor block 743 can be moved forward and backward in the front-rear direction by the operation of the sixth operation cylinder 745. In one example, the sixth operation cylinder 745 can include a pneumatic cylinder. The sixth operating cylinder 745 includes a third moving plate 746 that moves forward and backward along the front-rear direction.

The sensor block 743 is operationally connected to a seventh operating cylinder 747 installed on the third moving plate 746. The sensor block 743 can be moved forward and backward in the left-right direction by the operation of the seventh operation cylinder 747. In one example, the seventh operating cylinder 747 can include a pneumatic cylinder.

The head detecting sensors 744 are configured to detect the head part 8 of the I-shaped stator coils 7 inserted into the alignment jig 30. The head detecting sensors 744 are mounted spaced apart along the vertical direction on the sensor block 743.

Since the head detecting sensor 744 is well known to a person of ordinary skill in the art as a sensor that outputs and inputs detection sources such as infrared rays, a further detailed description will be omitted.

Hereinafter, the operation of the aligning apparatus for a hairpin type stator coil 100 will be described in detail with reference to FIG. 1 to FIG. 25.

In the previous process, the alignment jig 30, in which the U-shaped stator coils 5 are aligned, moves along the conveyor and docks with the jig docking part 70. The alignment jig 30 is maintained in a rotatable state at a predetermined rotation speed and rotating direction by the docking driver 71 of the jig docking part 70.

At least one storage 210 is provided, in which the I-shaped stator coils 7 formed in the coil forming process are loaded. The I-shaped stator coils 7 are loaded along the oblique direction on the storage guides 231.

The storage door 241 of at least one storage 210 supports the I-shaped stator coils 7 loaded on the storage guides 231. That is, the storage door 241 blocks the sliding of the I-shaped stator coils 7 and closes the front portion of the storage body 221.

The door plate 243 of the storage door 241 is in a state of forward movement in one direction together with the upper storage stopper 245, the medium storage stopper 247, and the lower storage stopper 249 by the elastic force of the spring 253.

The at least one storage 210 is loaded onto the stack base 311 of the storage stacking portion 310 by a storage loading unit.

The storage base 211 of at least one storage 210 is mounted on the rail blocks 313 of the stack base 311.

The docking block 323 of the storage docking cylinder 321 is fitted into the connecting block 213 of the storage base 211. The docking block 323 is in a state of being moved backwards by the operation of the storage docking cylinder 321.

When the docking block 323 moves forward by the operation of the storage docking cylinder 321, at least one storage 210 moves forward along the rail blocks 313 through the storage base 211.

When the pin joint grooves 217 of the storage base 211 engage with the storage docking pins 315 of the stack base 311, at least one storage 210 docks with at least one cartridge 410.

The storage guides 231 of at least one storage 210 are connected along the slope direction with the cartridge guides 421 of at least one cartridge 410. The door operating bracket 263 of the storage door driver 261 is in a forward movement state by the operation of the storage door operating cylinder 265.

The door operating bracket 263 moves backwards by the operation of the storage door operating cylinder 265. Then, the door plate 243 of the storage door 241 overcomes the elastic force of the spring 253 by the door operating bracket 263 and moves backward in the other direction.

The door plate 243 moves backwards in the other direction together with the upper storage stopper 245, the medium storage stopper 247, and the lower storage stopper 249.

Accordingly, the upper storage stopper 245, the medium storage stopper 247, and the lower storage stopper 249 release the stops of the I-shaped stator coils 7 loaded on the storage guides 231. That is, the storage door 241 opens the front portion of the storage body 221.

As the storage door 241 is opened, a predetermined number of the I-shaped stator coils 7 loaded on the storage guides 231 slide from the rear to the front along the incline direction of the storage guides 231. Accordingly, the I-shaped stator coils 7 are loaded along the oblique direction on the cartridge guides 421 of at least one cartridge 410.

The main stopper 431 of at least one cartridge 410 prevents sliding of the I-shaped stator coils 7 loaded on the cartridge guides 421.

The head stopper 433 of the main stopper 431 is in a forward movement state by the operation of the upper main driving cylinder 437. The head stopper 433 supports the head part 8 of the I-shaped stator coils 7.

In some examples, the leg stopper 435 of the main stopper 431 is rotated to the rearward side through the stopper mount block 443 by the forward operation of the lower main driving cylinder 439. The leg stopper 435 supports leg part 9 of the I-shaped stator coils 7.

The upper stopper block assembly 451 and the lower stopper block assembly 461 of at least one cartridge 410 are moved backward in the left-right direction as the stopper driving block 473 is moved backward by the operation of the sub-stopper driving cylinder 471.

The upper cam protrusion 474a and the lower cam protrusion 474b of the stopper driving block 473 are respectively connected to the upper cam follower 457 of the upper stopper block assembly 451 and the lower cam follower 467 of the lower stopper block assembly 461.

Therefore, when the stopper driving block 473 is moved backwards, the upper stopper block assembly 451 and the lower stopper block assembly 461 can be moved backwards by the cam coupling structure with the stopper driving block 473 as described above.

The coil clamper 481 and the sub-stopper 491 of at least one cartridge 410 are moved backward by the upper stopper block assembly 451 and the lower stopper block assembly 461.

In this state, the stopper driving block 473 moves forward by the operation of the sub-stopper driving cylinder 471. Then, the upper stopper block assembly 451 and the lower stopper block assembly 461 move forward by the cam coupling structure with the stopper driving block 473 as described above.

Accordingly, since the coil clamper 481 is mounted on the upper stopper block assembly 451, it moves forward by the forward movement of the upper stopper block assembly 451. Then, the coil clamper 481 clamps the I-shaped stator coils 7 arranged at the rear of the frontmost I-shaped stator coil 7 among the I-shaped stator coils 7 loaded on the cartridge guides 421.

In some examples, since the sub-stopper 491 is mounted on the upper stopper block assembly 451 and the lower stopper block assembly 461, it moves forward by the forward movement of the upper stopper block assembly 451 and the lower stopper block assembly 461. At this time, at least one upper cartridge stopper 493 and at least one lower cartridge stopper 495 of the sub-stopper 491 close the front portion of the cartridge body 411.

Here, the frontmost I-shaped stator coil 7 is not clamped by the coil clamper 481, and is stopped by the head stopper 433 and leg stopper 435 of the main stopper 431.

Simultaneously, the head stopper 433 moves backward by the operation of the upper main driving cylinder 437, and the leg stopper 435 swings and rotates forward by the operation of the lower main driving cylinder 439. Accordingly, the head stopper 433 and the leg stopper 435 release the stopping of the head part 8 and the leg part 9 of the frontmost I-shaped stator coil 7.

Therefore, the frontmost I-shaped stator coil 7 slides from the rear to the front along the inclination direction of the cartridge guides 421. In some examples, the frontmost I-shaped stator coil 7 is stopped by at least one upper cartridge stopper 493 and at least one lower cartridge stopper 495 of the sub-stopper 491.

With the I-shaped stator coil 7 of the frontmost part sliding, the head stopper 433 moves forward by the operation of the upper main driving cylinder 437, and the leg stopper 435 swings and rotates rearward by the operation of the lower main driving cylinder 439. Accordingly, the head stopper 433 and the leg stopper 435 support the head part 8 and the leg part 9 of the I-shaped stator coils 7 arranged at the rear of the frontmost I-shaped stator coil 7.

Then, the robot gripper 510 moves toward the front portion of the cartridge body 411 by the robot movement of the handling robot 511.

The moving block 531 of the robot gripper 510 is moved backward together with the gripper bodies 541 by the operation of the gripper sub-driving cylinder 533. In some examples, the gripper bodies 541 are moved backwards in a direction away from each other by the operation of the gripper main driving cylinder 543.

In this state, the moving block 531 moves forward toward the frontmost I-shaped stator coil 7 together with the gripper bodies 541 by the operation of the gripper sub-driving cylinder 533. In some examples, the gripper bodies 541 move forward in a direction toward each other by the operation of the gripper main driving cylinder 543.

Then, the gripper bodies 541 grip the leg part 9 of the frontmost I-shaped stator coil 7 through the gripping groove 545.

At this time, when the leg part 9 deviates from the gripping groove 545 due to the posture of the frontmost I-shaped stator coil 7 being distorted, at least one gradient protrusion 547 and at least one gradient groove portion 549 of the gripper bodies 541 overlap each other to guide the frontmost I-shaped stator coil 7 into the gripping groove 545.

Additionally, the coil detecting sensor 581 detects the I-shaped stator coil 7 gripped by the gripper bodies 541 and outputs a detection signal to the controller. Accordingly, the controller can determine whether the I-shaped stator coil 7 is pulled out or has a gripping defect by analyzing the detection signal of the coil detecting sensor 581.

The gripper bodies 541 grip the frontmost I-shaped stator coil 7, and simultaneously, the upper stopper block assembly 451 and the lower stopper block assembly 461 move backwards by the operation of the sub-stopper driving cylinder 471.

Accordingly, the upper stopper block assembly 451 and the lower stopper block assembly 461 move backward by the cam coupling structure with the stopper driving block 473.

The coil clamper 481 moves backwards by the backward movement of the upper stopper block assembly 451, releasing the clamping of the I-shaped stator coils 7.

In some examples, by the backward movement of the upper stopper block assembly 451 and the lower stopper block assembly 461, at least one upper cartridge stopper 493 and at least one lower cartridge stopper 495 of the sub-stopper 491 move backward, thereby opening the front portion of the cartridge body 411.

Next, the robot gripper 510, which is gripping the I-shaped stator coil 7 of the frontmost part, moves toward the alignment jig 30 by the operation of the handling robot 511.

Therefore, the aligning apparatus for a hairpin type stator coil 100 can repeat a series of processes as described above, extract I-shaped stator coils 7 loaded in at least one cartridge 410 one by one, and transfer them to the alignment jig 30 side through the robot gripper 510.

With the alignment jig 30, in which the U-shaped stator coils 5 are aligned, docked with the jig docking part 70, the fixing plate 621 of the pocket moving unit 610 is placed at a predetermined position along the left-right direction by the operation of the first operation cylinder 623.

The fixing plate 621 is moved upward together with the cam blocks 631 by the operation of the second operation cylinder 625. In some examples, the cam blocks 631 are arranged at positions corresponding to the pocket blocks 53 of the coil pocket units 51 on the upper side of the alignment jig 30.

In this state, the fixing plate 621 moves downward by the operation of the second operation cylinder 625, and the cam blocks 631 come into cam contact with the cam roller 63 of the pocket block 53. Then, the pocket block 53 of the coil pocket units 51 moves outside the radius of the support ring 41 together with the guide blocks 55.

Therefore, interference between the U-shaped stator coils 5 and the coil pocket units 51 aligned to the alignment jig 30 can be avoided.

Then, the jig support block 733 of the jig supporter 731 of the alignment assist unit 710 moves forward by the operation of the fifth operation cylinder 735 at a position corresponding to the alignment jig 30. The support protrusion 737 and support surface 739 of the jig support block 733 are positioned with a predetermined clearance from the jig pins 37.

Then, the pull block 723 of the coil extension part 721 of the alignment assist unit 710 moves forward in the upward direction by the operation of the fourth operation cylinder 727, and moves forward toward the U-shaped stator coils 5 by the operation of the third operation cylinder 725.

Next, the pull block 723 moves backward in the downward direction by the operation of the fourth operation cylinder 727. Then, the pull finger 729 is inserted into the U-shaped stator coil 5, and the pull block 723 moves backward by the operation of the third operation cylinder 725.

Accordingly, the pull block 723 pulls the U-shaped stator coils 5 outside the radius of the alignment jig 30, thereby securing space for insertion of the I-shaped stator coils 7 into a predetermined position of the alignment jig 30 (e.g., the inner layer of the jig pins 37).

When the pull block 723 of the coil extension part 721 pulls the U-shaped stator coils 5, the jig support block 733 of the jig supporter 731 supports the alignment jig 30 that is moved by the coil extension part 721.

The robot gripper 510, which is gripping the I-shaped stator coil 7, moves in a downward direction by the operation of the handling robot 511 on a predetermined position of the alignment jig 30.

When the I-shaped stator coil 7 is interfered with by an obstacle, the I-shaped stator coil 7 slips in an upward direction between the gripper bodies 541 of the robot gripper 510.

In this case, the sensor dog block 561 of the robot gripper 510 is moved upward by the I-shaped stator coil 7 which slips in the upward direction.

Then, the proximity sensor 571 of the robot gripper 510 detects the upward movement of the sensor dog block 561 and outputs a detection signal to the controller. Accordingly, the controller can determine the insertion defect of the I-shaped stator coil 7 by analyzing the detection signal.

The robot gripper 510, which is gripping the I-shaped stator coil 7, moves in a downward direction on a predetermined position of the alignment jig 30, and the gripper bodies 541 move backward in a direction away from each other by the operation of the gripper main driving cylinder 543, thereby releasing the I-shaped stator coil 7.

Accordingly, the I-shaped stator coil 7 freely falls from a predetermined position on the alignment jig 30. Simultaneously, the moving block 531 of the robot gripper 510 moves backward together with the gripper bodies 541 by the operation of the gripper sub-driving cylinder 533. During this process, the coil guide pins 551 of the robot gripper 510 support the head part 8 of the I-shaped stator coil 7.

Therefore, the I-shaped stator coil 7 can be inserted into the jig pins 37 of the alignment jig 30 while maintaining the correct position without interference between the head part 8 and the gripper bodies 541.

When the I-shaped stator coil 7 is inserted into a predetermined position of the alignment jig 30 and aligned with the jig pins 37, the pull block 723 of the coil extension part 721 is returned to the original position by the operation of the third operation cylinder 725 and the fourth operation cylinder 727.

Then, when the alignment jig 30 is rotated at a predetermined rotation angle by the operation of the docking driver 71 of the jig docking part 70, the I-shaped stator coils 7 can be aligned to the alignment jig 30 by a series of repetitive processes as described above.

The sensor block 743 of the coil detector 741 of the alignment assist unit 710 is moved forward along the front-rear direction together with the head detecting sensors 744 by the operation of the sixth operation cylinder 745.

In this state, when the alignment jig 30 rotates, the head detecting sensors 744 detect the head part 8 of the I-shaped stator coils 7 aligned to the alignment jig 30 and output a detection signal to the controller. Accordingly, the controller can determine insertion failure (or misalignment) of the I-shaped stator coils 7 by analyzing the detection signal of the head detecting sensors 744.

At least one head part 8 of the I-shaped stator coils 7 aligned on the alignment jig 30 can interfere with the sensor block 743 of the coil detector 741 at a predetermined alignment position of the I-shaped stator coil 7.

To prevent this, the sensor block 743 is moved forward and backward in the left-right direction by the operation of the seventh operation cylinder 747. Accordingly, the head detecting sensors 744 can smoothly detect the head part 8 of the I-shaped stator coils 7 while avoiding interference between the sensor block 743 and the head part 8 of the stator coil 7.

Meanwhile, in the process of aligning the I-shaped stator coils 7 to the predetermined positions of the alignment jig 30, the I-shaped stator coils 7 can be aligned to the jig springs 39.

Here, the jig springs 39 can buffer the load of the aligned stator coils 1 and secure a movement space in which the I-shaped stator coils 7 can be inserted.

When the I-shaped stator coils 7 are inserted between the stator coils 1 that are already inserted between the jig pins 37, the jig pins 37 can spread apart, causing a collision with the adjacent stator coils 1.

Therefore, since the jig springs 39 are mounted in the interference section where the collision between the jig pins 37 and the stator coils 1 occurs, the jig springs 39 can reduce the load applied to the stator coils 1.

In some examples, the I-shaped stator coils 7 can be inserted into the alignment jig 30 through the guide blocks 55 moved outwardly along with the pocket blocks 53 on the support ring 41 of the alignment jig 30.

The I-shaped stator coils 7 can be inserted into the outer layer of the alignment jig 30 through the pocket guide holes 61 of the guide blocks 55. The pocket guide hole 61 is formed in a shape where the interior diameter gradually decreases from top to bottom.

Therefore, even if dispersion occurs in the insertion positions of the I-shaped stator coils 7, the I-shaped stator coils 7 can be accurately inserted into a predetermined position of the alignment jig 30 through the pocket guide hole 61.

In some examples, with the I-shaped stator coils 7 aligned on the alignment jig 30 where the U-shaped stator coils 5 are aligned, the sensor block 743 of the coil detector 741 is returned to the original position by the operation of the sixth operation cylinder 745 and the seventh operation cylinder 747. The original position here can be defined as a position away from the stator coils 1 aligned to the alignment jig 30, i.e., a position where the sensor block 743 and the stator coils 1 do not interfere.

In this state, the stator coils 1 of the U-shaped stator coils 5 and the I-shaped stator coils 7 aligned on the alignment jig 30 can be taken out from the alignment jig 30 by a clamping device and inserted into the slots of the stator core.

The aligning apparatus for a hairpin type stator coil 100 as described so far can automatically align the I-shaped stator coils 7 to the alignment jig 30 in which the U-shaped stator coils 5 are already aligned.

Therefore, the aligning apparatus for a hairpin type stator coil 100 can implement process automation, thereby reducing labor costs and shortening the cycle time.

In addition, the aligning apparatus for a hairpin type stator coil 100 can align the I-shaped stator coils 7 to the alignment jig 30 at high speed by process automation, thereby improving equipment driving efficiency.

In some examples, since the aligning apparatus for a hairpin type stator coil 100 can implement process automation, additional devices such as a fool proof device for verifying the alignment state of the I-shaped stator coils 7 and a logistics device for discharging and re-introducing the alignment jig due to misalignment of the I-shaped stator coils 7 can be eliminated.

Furthermore, the aligning apparatus for a hairpin type stator coil 100 absorbs position dispersion of the I-shaped stator coils 7 by at least one cartridge 410, the robot gripper 510, the coil pocket unit 51, the pocket moving unit 610, and the alignment assist unit 710, and can align the I-shaped stator coils 7 to the alignment jig 30.

Therefore, the aligning apparatus for a hairpin type stator coil 100 can improve the insertion property of the I-shaped stator coils 7 for the alignment jig 30 and enhance the alignment quality of the I-shaped stator coils 7.

Furthermore, the aligning apparatus for a hairpin type stator coil 100 applies the jig pins 37 and the jig springs 39 having open-type insertion spaces to the alignment jigs 30.

Accordingly, the aligning apparatus for a hairpin type stator coil 100 can avoid structural interference of the stator coils 7 and reduce the manufacturing cost of the alignment jigs 30.

Although the various implementations have been described above, the present disclosure is not limited thereto, and various modifications can be made within the scope of the claims, the detailed description of the disclosure, and the attached drawings, which also fall within the scope of the present disclosure.

What is claimed is:

1. An aligning apparatus configured to align I-shaped stator coils to an alignment jig in which U-shaped stator coils are aligned, the aligning apparatus comprising:
a frame;
a storage stacking portion disposed at the frame;
at least one storage configured to load the I-shaped stator coils, the at least one storage comprising storage guides that are disposed at the storage stacking portion and inclined downward from a rear side of the least one storage to a front side of the least one storage;
at least one cartridge disposed forward relative to the at least one storage and configured to receive the I-shaped stator coils from the at least one storage, the least one cartridge comprising cartridge guides that are arranged in a downward direction from the rear side to the front side and configured to output the I-shaped stator coils one by one; and
a gripper configured to (i) move along a predetermined path, (ii) grip and un-grip the I-shaped stator coils that are output from the at least one cartridge one by one, and (iii) insert each of the I-shaped stator coils into a predetermined position in the alignment jig.

2. The aligning apparatus of claim 1, wherein the storage stacking portion comprises:
a stack base fixed to the frame; and
a storage docking cylinder disposed at the stack base and connected to the at least one storage.

3. The aligning apparatus of claim 2, wherein the at least one storage further comprises:
a storage base connected to the storage docking cylinder and configured to move in a front-rear direction relative to the stack base;
a storage body that is fixed to the storage base and supports the storage guides;
a storage door deposited at a front of the storage body and configured to support the I-shaped stator coils loaded in the storage guides; and
a storage door driver disposed at the stack base and configured to open and close the storage door.

4. The aligning apparatus of claim 3, wherein the at least one storage further comprises a door mount block fixed to the storage base, and
wherein the storage door comprises:
a door plate disposed at the door mount black and configured to move in a left-right direction on the door mount block; and
a plurality of storage stoppers comprising an upper storage stopper, a medium storage stopper, and a lower storage stopper that are arranged at the door plate along a vertical direction.

5. The aligning apparatus of claim 4, wherein the storage door driver comprises:
a door operating bracket disposed at the stack base and configured to move in the left-right direction relative to the stack base, the door bracket being configured to move the door plate in the left-right direction; and
a storage door operating cylinder disposed at the stack base and connected to the door operating bracket.

6. The aligning apparatus of claim 1, wherein the at least one cartridge comprises:
a cartridge body disposed at the frame, the cartridge body including the cartridge guides configured to connect to the storage guides;
a main stopper disposed at a front portion of the cartridge body and configured to support the I-shaped stator coils loaded on the cartridge guides;
an upper stopper block assembly and a lower stopper block assembly that are disposed at the front portion of the cartridge body and configured to move in the left-right direction;
a stopper driving block configured to move forward and backward along the front-rear direction;
a sub-stopper driving cylinder disposed at the cartridge body and connected to the upper stopper block assembly and the lower stopper block assembly through the stopper driving block;
a coil clamper disposed at the upper stopper block assembly and configured to clamp the I-shaped stator coils positioned behind a frontmost I-shaped stator coil among the I-shaped stator coils loaded on the cartridge guides; and
a sub-stopper disposed at each of the upper stopper block assembly and the lower stopper block assembly and configured to support and extract the frontmost I-shaped stator coil.

7. The aligning apparatus of claim 6, wherein the at least one cartridge comprises further comprises an upper main driving cylinder and a lower main driving cylinder that are disposed at the cartridge body, and
wherein the main stopper comprises:
a head stopper connected to the upper main driving cylinder and configured to support head parts of the I-shaped stator coils loaded on the cartridge guides; and
a leg stopper connected to the lower main driving cylinder and configured to support leg parts of the I-shaped stator coils loaded on the cartridge guides.

8. The aligning apparatus of claim 6, further comprising:
an upper cam protrusion disposed at an upper side of the stopper driving block;
a lower cam protrusion disposed at a lower side of the stopper driving block;
an upper cam follower portion connected to the upper cam protrusion portion and disposed diagonally along the front-rear direction of the upper stopper block assembly; and
a lower cam follower connected to the lower cam protrusion and disposed diagonally along the front-rear direction of the lower stopper block assembly.

9. The aligning apparatus of claim 6, wherein the sub-stopper comprises:
at least one upper cartridge stopper disposed at the upper stopper block assembly and configured to support a head part of the frontmost I-shaped stator coil; and
at least one lower cartridge stopper disposed at the lower stopper block assembly and configured to support a leg part of the frontmost I-shaped stator coil.

10. The aligning apparatus of claim 1, wherein the gripper comprises:
a mounting bracket;
a gripper sub-driving cylinder disposed at the mounting bracket;
a moving block configured to enable forward and backward movements of the gripper based on operation of the gripper sub-driving cylinder;
a gripper main driving cylinder disposed at the moving block;
a pair of gripper bodies configured to move toward each other or away from each other based on operation of the gripper main driving cylinder; and
a pair of coil guide pins disposed at the moving block.

11. The aligning apparatus of claim 10, wherein the gripper further comprises:
a fixing bracket fixed to the mounting bracket;
a sensor dog block disposed at the fixing bracket and configured to move in a vertical direction; and
a proximity sensor disposed at an upper side of the fixing bracket opposite to the sensor dog block.

12. The aligning apparatus of claim 10, wherein each of the pair gripper bodies defines a gripping groove that extends in a vertical direction and is configured to accommodate a leg part of one of the I-shaped stator coils, and
wherein one of the pair of gripper bodies comprises at least one gradient protrusion connected to one of the gripping grooves, and
wherein the other of the pair of gripper bodies defines at least one gradient groove portion connected to the other of the gripping grooves and configured to overlap with the at least one gradient protrusion.

13. The aligning apparatus of claim 1, further comprising a jig docking part disposed at the frame, and
wherein the alignment jig comprises:
a jig base;
a rotation shaft connected to the jig docking part and rotatably mounted at the jig base;
at least one fixing ring connected to the rotation shaft;
a plurality of jig pins radially arranged at the at least one fixing ring; and
at least one jig spring radially arranged in a predetermined exterior circumference section of the at least one fixing ring.

14. The aligning apparatus of claim 13, wherein the alignment jig further comprises:
a support ring fixed to the jig base, wherein the at least one fixing ring is disposed inside the support ring; and
a plurality of coil pocket units radially and movably disposed the support ring and configured to guide a leg part of each of the I-shaped stator coils to be inserted into a predetermined position of the plurality of jig pins by the gripper.

15. The aligning apparatus of claim 14, wherein each of the plurality of coil pocket units comprises:
a pocket block radially and movably connected to the support ring;
at least one guide rod that connects the pocket block to the support ring; and
at least one guide block that is connected to the pocket block and defines a pocket guide hole along a vertical direction.

16. The aligning apparatus of claim 15, further comprising a pocket moving unit connected to the jig docking part and configured to move the plurality of coil pocket units along an circumference of the support ring,
wherein each of the plurality of coil pocket units comprises a cam roller rotatably disposed at the pocket block, and
wherein the pocket moving unit comprises:
a base part connected to the jig docking part;
a first operation cylinder and a second operation cylinder that are disposed at the base part;
a fixing plate configured to move in a left-right direction and a vertical direction by operation of the first operation cylinder and the second operation cylinder; and
a plurality of cam blocks that are disposed at the fixing plate at positions corresponding to the pocket block, the plurality of cam blocks being in contact with the cam roller.

17. The aligning apparatus of claim 1, further comprising:
a coil extension part disposed at the frame at a position corresponding to the alignment jig, the coil extension part being configured to pull the U-shaped stator coils in the alignment jig;
a jig supporter disposed at the frame and configured to support the alignment jig based on the alignment jig being moved by the coil extension part; and
a coil detector disposed at the frame and configured to sense the I-shaped stator coils inserted into the alignment jig.

18. The aligning apparatus of claim 17, further comprising a plurality of operation cylinders disposed at the frame,
wherein the coil extension part comprises a pull block configured to move along a front-rear direction and in a vertical direction based on operation of the plurality of operation cylinders.

19. The aligning apparatus of claim 17, further comprising an operation cylinders disposed at the frame,
wherein the jig supporter comprises a jig support block configured to move in a front-rear direction based on operation of the operation cylinder.

20. The aligning apparatus of claim 17, further comprising a plurality of operation cylinders disposed at the frame,
wherein the coil detector comprises:
a sensor block configured to move in a front-rear direction and a left-right direction based on operation of the plurality of operation cylinders; and
a pair of head detecting sensors disposed on the sensor block along the vertical direction.
